(19) United States
(12) Patent Application Publication
(10) Pub. No.: US 2010/0265910 A1
(43) Pub. Date: Oct. 21, 2010

(54) METHOD, SYSTEM AND APPARATUS FOR ASSIGNING PILOT RESOURCES

(75) Inventors: Shiqiang Suo, Beijing (CN); Deshan Miao, Beijing (CN); Shaohui Sun, Beijing (CN); Libo Wang, Beijing (CN); Hai Tang, Beijing (CN)

Correspondence Address: HARNESS, DICKEY & PIERCE, P.L.C., P.O. BOX 828, BLOOMFIELD HILLS, MI, 48303, US

(73) Assignee: DA TANG MOBILE COMMUNICATIONS EQUIPMENT CO., LTD., Beijing (CN)

(21) Appl. No.: 12/741,024

(22) PCT Filed: Oct. 31, 2008
(86) PCT No.: PCT/CN2008/072905

§ 371 Date: Apr. 30, 2010

(30) Foreign Application Priority Data
Nov. 2, 2007 (CN) 200710176801.3

(51) Int. Cl. H04W 72/04

(52) U.S. Cl. 370/330

(57) ABSTRACT

Embodiments of the present invention provide a method, system and apparatus for assigning pilot resources. By assigning all or part of time and frequency resources of at least one configured SC-FDMA symbol in an UpPTS to an uplink SRS symbol and sending an assigning result to a mobile terminal, time and frequency resources in the UpPTS can be assigned to the uplink SRS symbol, so that after receiving the assigning result, the mobile terminal can send the uplink SRS symbol by using the time and frequency resources assigned to the uplink SRS symbol according to the assigning result.

### FIELD OF THE INVENTION

The present invention relates to mobile communication technologies, and more particularly to a method, system and apparatus for assigning pilot resources.

### BACKGROUND OF THE INVENTION

Time Division-Synchronization Code Division Multiple Access (TD-SCDMA) technology is a unique technology that adopts a Time Division Duplex (TDD) mode in three international standards of the 3^{rd} Generation Mobile Communication System. A TD-SCDMA system supports asymmetric traffic transmission on uplink and downlink, and has relatively large flexibility in spectrum utilization. In order to make the TD-SCDMA system have competitive power for a long time, it is needed to continuously evolve the TD-SCDMA system and improve the capability of the TD-SCDMA system.

In a Long-Term Evolution solution of the TD-SCDMA system (LTE TDD), the structure of a radio frame shown in FIG. 1 is adopted. FIG. 1 is a schematic diagram illustrating the structure of a radio frame in a LTE TDD system in the prior art. As shown in FIG. 1, the length of the radio frame is 10 ms, and the radio frame is divided into 2 radio half frames of 5 ms. Each radio half frame includes 4 subframes and one special region, each subframe includes two time slots of 0.5 ms, and the special region includes three special time slots which are a Downlink Pilot Time Slot (DwPTS), a Guard Period (GP) and an Uplink Pilot Time Slot (UpPTS) respectively. When a short Cyclic Prefix (CP) is adopted, the special region includes 14 uplink Single Carrier Frequency Division Multiple Access (SC-FDMA) symbols, and when an extended CP is adopted, the special region includes 12 SC-FDMA symbols.

In order to keep the flexibility of the TD-SCDMA system, the length of the UpPTS is variable. When the short CP is adopted, the length of the UpPTS may be between the length of 2 SC-FDMA symbols and the length of 11 SC-FDMA symbols, and when the extended CP is adopted, the length of the UpPTS may be between the length of 2 SC-FDMA symbols and the length of 9 SC-FDMA symbols. The first two SC-FDMA symbols in the UpPTS usually are assigned to a Physical Random Access Channel (PRACH) to send continuous uplink random access signals of 1.25M. FIG. 2a is a schematic diagram illustrating the structure of a special region when a short CP is adopted and the length of an UpPTS is the length of 11 SC-FDMA symbols, and FIG. 2b is a schematic diagram illustrating the structure of a special region when a short CP is adopted and the length of an UpPTS is the length of 2 SC-FDMA symbols. In a radio communication system, uplink channel measurement is very important, so an uplink Sounding Reference Signal (SRS) symbol including uplink channel measurement information also needs a reasonable resource assigning method. Currently, there is no SRS resource assigning method used for the SRS resource assignment of the special region in the TD-SCDMA system.

### SUMMARY OF THE INVENTION

Embodiments of the present invention provide a method for assigning pilot resources, so as to be convenient for assigning time and frequency resources in an UpPTS to an SRS symbol.

A method for assigning pilot resources includes:

assigning all or part of time and frequency resources of at least one configured uplink Single Carrier Frequency Division Multiple Access (SC-FDMA) symbol in an Uplink Pilot Time Slot (UpPTS) to an uplink Sounding Reference Symbol (SRS), and sending an assigning result to a mobile terminal.

A system for assigning pilot resources includes a base station and a mobile terminal, and

the base station is adapted to assign all or part of time and frequency resources of at least one configured uplink Single Carrier Frequency Division Multiple Access (SC-FDMA) symbol in an Uplink Pilot Time Slot (UpPTS) to an uplink Sounding Reference Symbol (SRS), and send an assigning result; and

the mobile terminal is adapted to receive the assigning result of the base station.

A base station includes a resource assigning module and a sending module, and

the resource assigning module is adapted to assign all or part of time and frequency resources of at least one configured uplink Single Carrier Frequency Division Multiple Access (SC-FCMA) symbol in an Uplink Pilot Time Slot (UpPTS) to an uplink Sounding Reference Symbol (SRS); and

the sending module is adapted to send an assigning result of the resource assigning module.

As can be seen from the above technical solutions, in the method, system and apparatus provided by the embodiments of the present invention, by assigning all or part of time and frequency resources of at least one configured SC-FDMA symbol in the UpPTS to an SRS symbol and sending an assigning result to a mobile terminal, the time and frequency resources in the UpPTS can be assigned to the SRS symbol, so that after receiving the assigning result, the mobile terminal can send the SRS symbol by using the time and frequency resources assigned to the SRS symbol according to the assigning result.

### BRIEF DESCRIPTION OF THE DRAWINGS

FIG. 1 is a schematic diagram illustrating the structure of a radio frame in a LTE TDD system in the prior art.

FIG. 2a is a schematic diagram illustrating the structure of a special region when a short CP is adopted and the length of an UpPTS is the length of 11 SC-FDMA symbols.

FIG. 2b is a schematic diagram illustrating the structure of a special region when a short CP is adopted and the length of an UpPTS is the length of 2 SC-FDMA symbols.

FIG. 3a is a schematic diagram illustrating a first resources assignment in which 2 SRS symbols are configured in accordance with an embodiment of the present invention.

FIG. 3b is a schematic diagram illustrating a second resources assignment in which 2 SRS symbols are configured in accordance with an embodiment of the present invention.

FIG. 3c is a schematic diagram illustrating a third resources assignment in which 2 SRS symbols are configured in accordance with an embodiment of the present invention.

FIG. 4 is a schematic diagram illustrating a system in accordance with an embodiment of the present invention.

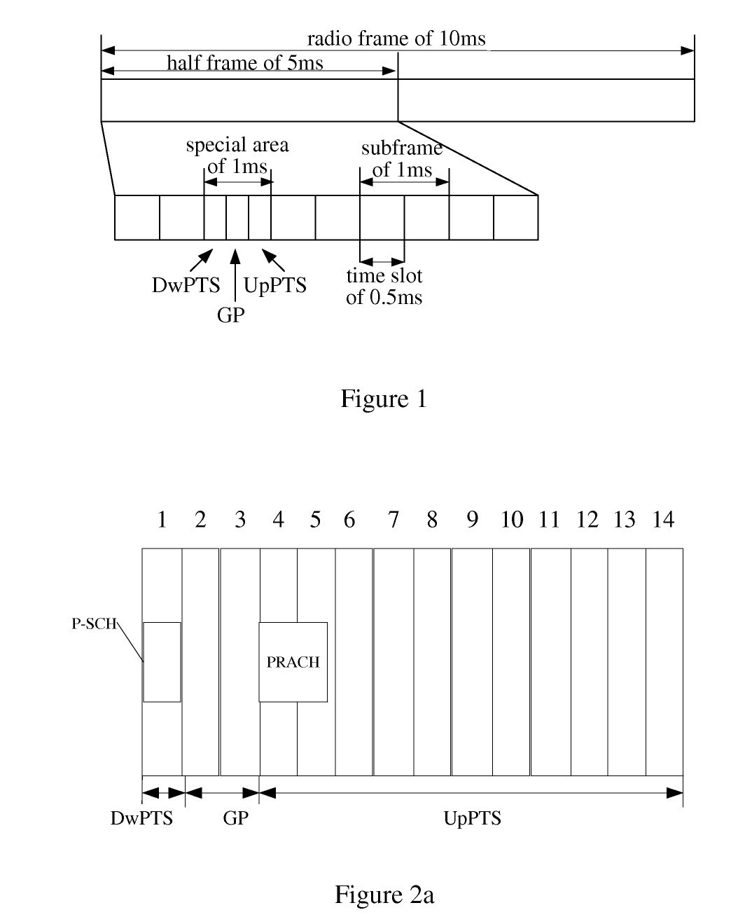

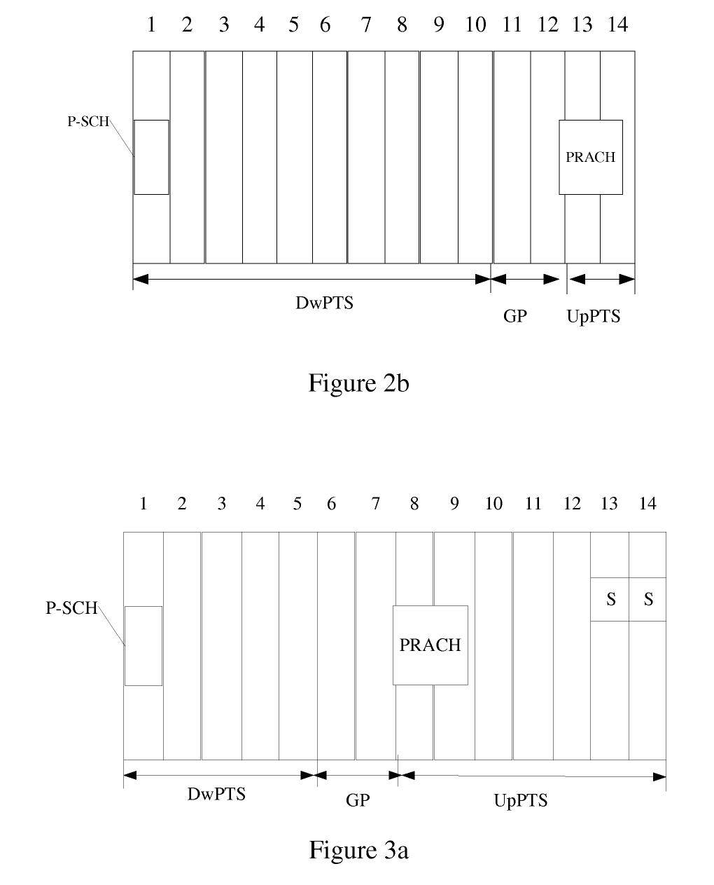

### DETAILED DESCRIPTION OF THE INVENTION

In order to make the object, solutions and merits of the present invention clearer, the present invention will be illustrated hereinafter in detail with reference to the accompanying drawings and specific embodiments.

The method provided by the embodiments of the present invention includes: in an UpPTS, assigning all or part of time and frequency resources of at least one configured SC-FDMA symbol to an SRS symbol, and sending an assigning result to a mobile terminal.

The part of time and frequency resources may be time and frequency resources corresponding to a measured frequency channel of the at least one configured SC-FDMA symbol.

Detailed descriptions are provided according to the following embodiments.

### The First Embodiment

All or part of time and frequency resources of the last SC-FDMA symbol in an UpPTS may be assigned to an SRS symbol. If a PRACH occupies part of time and frequency resources of the last SC-FDMA symbol, other time and frequency resources of the last SC-FDMA symbol except the time and frequency resources occupied by the PRACH are assigned to the SRS symbol, and an assigning result is sent to a mobile terminal through a system message. After receiving the assigning result, the mobile terminal sends the SRS symbol by using time and frequency resources corresponding to a measured frequency channel of the last SC-FDMA symbol. If the PRACH occupies part of time and frequency resources, the mobile terminal sends the SRS symbol by using time and frequency resources of other frequency channels in the last SC-FDMA symbol except the time and frequency resources of an frequency channel occupied by the PRACH, rather than sends the SRS symbol by using the time and frequency resources of the frequency channel occupied by the PRACH in the last SC-FDMA symbol.

### The Second Embodiment

All or part of time and frequency resources of the first SC-FDMA symbol in an UpPTS may be assigned to an SRS symbol. If a PRACH occupies part of time and frequency resources of the first SC-FDMA symbol, other time and frequency resources of the first SC-FDMA symbol except the time and frequency resources occupied by the PRACH are assigned to the SRS symbol, and an assigning result is sent to a mobile terminal through a system message. After receiving the assigning result, the mobile terminal sends the SRS symbol by using time and frequency resources corresponding to a measured frequency channel of the first SC-FDMA symbol. If the PRACH occupies part of time and frequency resources, the mobile terminal sends the SRS symbol by using time and frequency resources of other frequency channels in the first SC-FDMA symbol except the time and frequency resources of an frequency channel occupied by the PRACH, rather than sends the SRS symbol by using the time and frequency resources of the frequency channel occupied by the PRACH in the first SC-FDMA symbol.

### The Third Embodiment

When at least one SRS symbol needs to be sent, all or part of time and frequency resources of at least one configured SC-FDMA symbol in an UpPTS may be assigned to the at least one SRS symbol. Similarly, if a PRACH occupies time and frequency resources corresponding to a measured frequency channel of the at least one configured SC-FDMA symbol, other time and frequency resources of the at least one configured SC-FDMA symbol except the time and frequency resources occupied by the PRACH are assigned to the at least one SRS symbol, and an assigning result is sent to a mobile terminal through a system message. After receiving the assigning result, the mobile terminal sends the at least one SRS symbol by using the time and frequency resources corresponding to the measured frequency channel of the at least one configured SC-FDMA symbol. If the PRACH occupies part of time and frequency resources, the mobile terminal sends the at least one SRS symbol by using other time and frequency resources except the time and frequency resources occupied by the PRACH, rather than sends the at least one SRC symbol by using the time and frequency resources occupied by the PRACH.

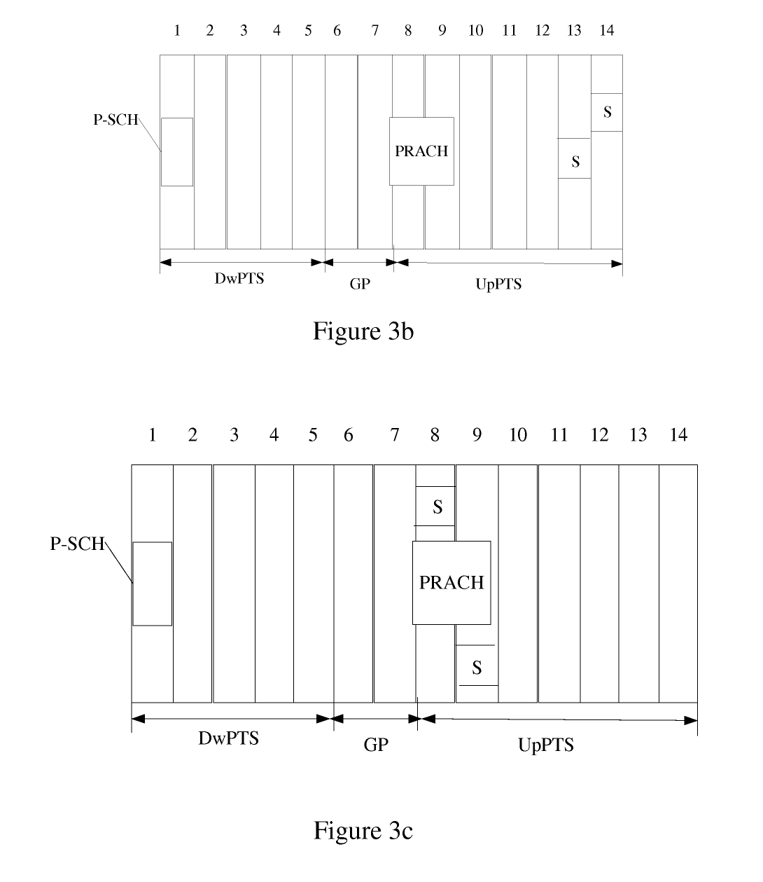

For example, when two SRS symbols need to be sent, time and frequency resources of the last two SC-FDMA symbols in the UpPTS may be respectively assigned to the two SRS symbols. The two SRS symbols may be in the same frequency channel of the two SC-FDMA symbols, or respectively in different frequency channels of the two SC-FDMA symbols. In other words, time and frequency resources of the same frequency channel in the last two SC-FDMA symbols in the UpPTS may be assigned to the two SRS symbols, as shown in FIG. 3a, in which S represents an SRS symbol; time and frequency resources of different frequency channels in the last two SC-FDMA symbols may be assigned to the two SRS symbols, as shown in FIG. 3b.

Time and frequency resources corresponding to a measured frequency channel of the first two SC-FDMA symbols in the UpPTS may be assigned to the two SRS symbols. Similarly, the two SRS symbols may be in the same frequency channel or respectively in different frequency channels. In other words, time and frequency resources of the same frequency channel in the first two SC-FDMA symbols in the UpPTS may be assigned to the two SRS symbols, or time and frequency resources of different frequency channels in the first two SC-FDMA symbols may be assigned to the two SRS symbols. If the time and frequency resources assigned to the SRS symbols collide with those assigned to a PRACH, time and frequency resources of other frequency channels except time and frequency resources of a frequency channel occupied by the PRACH may be assigned to the SRS symbols. Similarly, the two SRS symbols may be configured in the same frequency channel or respectively in different frequency channels, as shown in FIG. 3c.

In the above embodiments, if the time and frequency resources assigned to the SRS symbols have been assigned to an uplink pilot symbol, the time and frequency resources are assigned to the SRS symbols, and time and frequency resources after the SRS symbols are assigned to the uplink pilot symbol.

In addition, in the above embodiments, a base station may obtain antenna information of the mobile terminal and assign all or part of time and frequency resources of the at least one configured SC-FDMA symbol in the UpPTS to the SRS symbols according to the antenna information of the mobile terminal. For example, if the mobile terminal includes multiple antennae, the base station may assign time and frequency resources of multiple SC-FDMA symbols to the SRS symbols, so that the mobile terminal can send the SRS symbols corresponding to the multiple antennae in a time division mode by using the time and frequency resources of the multiple SC-FDMA symbols; the base station may also assign time and frequency resources of one SC-FDMA symbol to the SRS symbols, so that the mobile terminal can send the SRS symbols corresponding to the multiple antennae in a frequency division mode by using the time and frequency resources of the one SC-FDMA symbol.

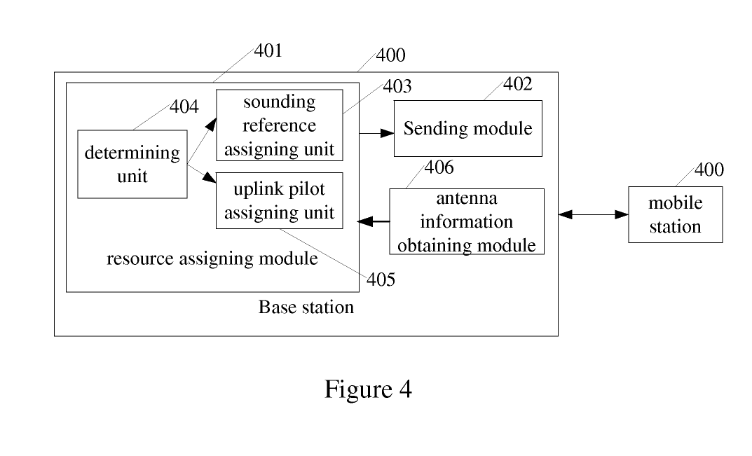

FIG. 4 is a schematic diagram illustrating a system in accordance with an embodiment of the present invention. As shown in FIG. 4, the system includes a base station 400 and a mobile terminal 410.

The base station 400 is adapted to assign all or part of time and frequency resources of at least one configured SC-FCMA symbol in an UpPTS to an SRS symbol, and send an assigning result.

The mobile terminal 410 is adapted to receive the assigning result sent by the base station 400.

The base station 400 includes a resource assigning module 401 and a sending module 402.

The resource assigning module 401 is adapted to assign all or part of the time and frequency resources of the at least one configured SC-FCMA symbol to the SRS symbol.

The resource assigning module 401 may assign all time and frequency resources of the first SC-FDMA symbol, the last SC-FDMA symbol, the first two SC-FDMA symbols, the last two SC-FDMA symbols or configured multiple SC-FDMA symbols to the SRS symbol, or assign time and frequency resources corresponding to a measured frequency channel of the first SC-FDMA symbol, the last SC-FDMA symbol, the first two SC-FDMA symbols, the last two SC-FDMA symbols or the configured multiple SC-FDMA symbols to the SRS symbol.

The sending module 402 is adapted to send the assigning result of the resource assigning module 401.

The resource assigning module 401 includes a sounding reference assigning unit 403 and a determining unit 404.

The determining unit 404 is adapted to determine whether part of time and frequency resources in all time and frequency resources of the at least one SC-FDMA symbol or in the time and frequency resources corresponding to the measured frequency channel of the at least one SC-FDMA symbol have been assigned to a PRACH.

The sounding reference assigning unit 403 is adapted to, when the determining unit 404 determines that part of time and frequency resources have been assigned to the PRACH, assign the SRS symbol other time and frequency resources except those assigned to the PRACH in the all time and frequency resources of the at least one SC-FDMA symbol or in the time and frequency resources corresponding to the measured frequency channel of the at least one SC-FDMA symbol; when the determining unit 404 determines that no time and frequency resources have been assigned to the PRACH, assign all time and frequency resources of the at least one SC-FDMA symbol or the time and frequency resources corresponding to the measured frequency channel of the at least one SC-FDMA symbol to the SRS symbol.

The resource assigning module 401 also includes an uplink pilot assigning unit 405.

The determining unit 404 is further adapted to determine whether part of time and frequency resources in the all time and frequency resources of the at least one SC-FDMA symbol or in the time and frequency resources corresponding to the measured frequency channel of the at least one SC-FDMA symbol have been assigned to an uplink pilot symbol.

The uplink pilot assigning unit 405 is adapted to, when the determining unit 404 determines that part of time and frequency resources have been assigned to the uplink pilot symbol, assign the part of time and frequency resources assigned to the uplink pilot symbol to the SRS symbol, and assign time and frequency resources after the SRS symbol to the uplink pilot symbol.

The base station 400 further includes an antenna information obtaining unit 406, adapted to obtain antenna information of the mobile terminal, and send the antenna information to the resource assigning module 401.

The resource assigning module 401 is further adapted to receive the antenna information obtained by the antenna information obtaining unit 406, and assign the time and frequency resources to the SRS symbol according to the antenna information.

As can be seen from the above description, in the method, system and apparatus provided by the embodiments of the present invention, by assigning all or part of time and frequency resources of the at least one configured SC-FDMA symbol in the UpPTS to the SRS symbol and sending the assigning result to the mobile terminal, the time and frequency resources in the UpPTS can be assigned to the SRS symbol, so that after receiving the assigning result, the mobile terminal can send the SRS symbol by using the time and frequency resources assigned to the SRS symbol according to the assigning result.

In addition, the embodiments of the present invention provide several methods for assigning all or part of time and frequency resources of the at least one configured SC-FDMA symbol to the SRS symbol, and provide a specific solution when the assigned time and frequency resources collide with those assigned to the PRACH or assigned to the uplink pilot, so that the SRS resource assignment is more reasonable.

The foregoing is only exemplary embodiments of the present invention, and is not used to limit the present invention. Any modification, equivalent replacement and improvement made within the principle of the present invention should be covered under the protection scope of the present invention.

1.-14. (canceled)

15. A method for assigning pilot resources, comprising:
assigning all or part of time and frequency resources of at least one configured uplink Single Carrier Frequency Division Multiple Access (SC-FDMA) symbol in an Uplink Pilot Time Slot (UpPTS) to an uplink Sounding Reference Symbol (SRS), and sending an assigning result to a mobile terminal.

16. The method of claim 15, wherein the at least one SC-FDMA symbol comprises: the first SC-FDMA symbol in the UpPTS, the last SC-FDMA symbol in the UpPTS, the first two SC-FDMA symbols in the UpPTS, the last two SC-FDMA symbols in the UpPTS, or multiple configured SC-FDMA symbols in the UpPTS.

17. The method of claim 15, wherein when there is more than one configured SC-FDMA symbol, the time and frequency resources assigned to the uplink SRS symbol are in the same frequency channel or in different frequency channels.

18. The method of claim 15, wherein assigning all or part of time and frequency resources of at least one configured uplink SC-FDMA symbol in an UpPTS to an uplink SRS comprises:
assigning other time and frequency resources except the time and frequency resources assigned to the PRACH in the all or part of time and frequency resources of the at least one configured SC-FDMA symbol to the uplink SRS symbol when part of time and frequency resources in the all or part of time and frequency resources of the at least one configured SC-FDMA symbol have been assigned to a Physical Random Access Channel (PRACH).

19. The method of claim 15, wherein assigning all or part of time and frequency resources of at least one configured uplink SC-FDMA symbol in an UpPTS to an uplink SRS comprises:
when part of time and frequency resources in the all or part of time and frequency resources of the at least one configured SC-FDMA symbol have been assigned to an uplink pilot symbol, assigning the part of time and frequency resources assigned to the uplink pilot symbol are assigned to the uplink SRS symbol, and assigning time and frequency resources after the uplink SRS symbol to the uplink pilot symbol.

20. The method of claim 15, further comprising:
sending, by the mobile terminal, the uplink SRS symbol by using the time and frequency resources assigned to the uplink SRS symbol after receiving the assigning result.

21. The method of claim 15, further comprising:
obtaining antenna information of the mobile terminal, and performing the steps of assigning the time and frequency resources according to the antenna information of the mobile terminal.

22. The method of claim 21, further comprising:
if the mobile terminal includes multiple antennae, assigning, by a base station, time and frequency resources of multiple SC-FDMA symbols to the uplink SRS symbol, and sending, by the mobile terminal after receiving the assigning result, the uplink SRS symbol corresponding to the multiple antennae in a time division mode by using the time and frequency resources of the multiple SC-FDMA symbols; or
assigning, by the base station, time and frequency resources of one SC-FDMA symbols to the uplink SRS symbol, and sending, by the mobile terminal after receiving the assigning result, the uplink SRS symbol corresponding to the multiple antennae in a frequency division mode by using the time and frequency resources of the one SC-FDMA symbols.

23. The method of claim 15, wherein the part of time and frequency resources assigned to the uplink SRS symbol is time and frequency resources corresponding to a measured frequency channel in the at least one configured SC-FDMA symbol.

24. The method of claim 20, wherein sending, by the mobile terminal, the uplink SRS symbol by using the time and frequency resources assigned to the uplink SRS symbol comprises:
sending, by the mobile terminal, the uplink SRS symbol by using time and frequency resources corresponding to a measured frequency channel of the first SC-FDMA symbol in the UpPTS, and if a PRACH occupies part of time and frequency resources, sending, by the mobile terminal, the uplink SRS symbol by using time and frequency resources of other frequency channels in the first SC-FDMA symbol except the time and frequency resources of an frequency channel occupied by the PRACH; and
sending, by the mobile terminal, the uplink SRS symbol by using time and frequency resources corresponding to a measured frequency channel of the last SC-FDMA symbol in the UpPTS, and if a PRACH occupies part of time and frequency resources, sending, by the mobile terminal, the uplink SRS symbol by using time and frequency resources of other frequency channels in the last SC-FDMA symbol except the time and frequency resources of an frequency channel occupied by the PRACH.

25. The method of claim 20, wherein sending, by the mobile terminal, the uplink SRS symbol by using the time and frequency resources assigned to the uplink SRS symbol comprises:
sending, by the mobile terminal, the uplink SRS symbol by using time and frequency resources corresponding to a measured frequency channel of the first two SC-FDMA symbol in the UpPTS, and if a PRACH occupies part of time and frequency resources, sending, by the mobile terminal, the uplink SRS symbol by using time and frequency resources of other frequency channels in the first two SC-FDMA symbol except the time and frequency resources of an frequency channel occupied by the PRACH; and
sending, by the mobile terminal, the uplink SRS symbol by using time and frequency resources corresponding to a measured frequency channel of the last two SC-FDMA symbol in the UpPTS, and if a PRACH occupies part of time and frequency resources, sending, by the mobile terminal, the uplink SRS symbol by using time and frequency resources of other frequency channels in the last two SC-FDMA symbol except the time and frequency resources of an frequency channel occupied by the PRACH.

26. A system for assigning pilot resources, comprising a base station and a mobile terminal, wherein
the base station is adapted to assign all or part of time and frequency resources of at least one configured uplink Single Carrier Frequency Division Multiple Access (SC-FDMA) symbol in an Uplink Pilot Time Slot (UpPTS) to an uplink Sounding Reference Symbol (SRS), and send an assigning result; and
the mobile terminal is adapted to receive the assigning result of the base station.

27. A base station, comprising a resource assigning module and a sending module, wherein
the resource assigning module is adapted to assign all or part of time and frequency resources of at least one configured uplink Single Carrier Frequency Division Multiple Access (SC-FCMA) symbol in an Uplink Pilot Time Slot (UpPTS) to an uplink Sounding Reference Symbol (SRS); and
the sending module is adapted to send an assigning result of the resource assigning module.

28. The base station of claim 27, wherein the resource assigning module comprises a sounding reference assigning unit and a determining unit;
the determining unit is adapted to determine whether part of time and frequency resources in the all time and frequency resources or in time and frequency resources corresponding to a measured frequency channel of the at least one configured SC-FDMA symbol have been assigned to a Physical Random Access Channel (PRACH); and
the sounding reference assigning unit is adapted to, when the determining unit determines that part of time and frequency resources have been assigned to the PRACH, assign the uplink SRS symbol other time and frequency resources except the time and frequency resources assigned to the PRACH in the all time and frequency resources or in the time and frequency resources corresponding to the measured frequency channel of the at least one configured SC-FDMA symbol; when the determining unit determines that no time and frequency resources have been assigned to the PRACH, assign the all time and frequency resources or the time and frequency resources corresponding to the measured frequency channel of the at least one configured SC-FDMA symbol to the uplink SRS symbol.

29. The base station of claim 28, wherein the resource assigning module further comprises an uplink pilot assigning unit;
the determining unit is further adapted to determine whether part of time and frequency resources in the all time and frequency resources or in the time and frequency resources corresponding to the measured frequency channel of the at least one configured SC-FDMA symbol have been assigned to an uplink pilot symbol;
the uplink pilot assigning unit is adapted to, when the determining unit determines that part of time and frequency resources have been assigned to the uplink pilot symbol, assign the part of time and frequency resources assigned to the uplink pilot symbol to the uplink SRS symbol, and assign time and frequency resources after the uplink SRS symbol to the uplink pilot symbol.

30. The base station of claim 27, further comprising an antenna information obtaining module, adapted to obtain antenna information of a mobile terminal, and send the antenna information to the resource assigning module;
the resource assigning module is further adapted to receive the antenna information obtained by the antenna information obtaining module, and perform the steps of assigning the time and frequency resources to the uplink SRS symbol according to the antenna information.
